(19) United States
(12) Patent Application Publication
(10) Pub. No.: US 2018/0047206 A1
(43) Pub. Date: Feb. 15, 2018

(54) VIRTUAL MAPPING OF FINGERPRINTS FROM 3D TO 2D

(71) Applicant: 3M INNOVATIVE PROPERTIES COMPANY, Saint Paul, MN (US)

(72) Inventors: Ravishankar SIVALINGAM, Foster City, CA (US); Glenn E. CASNER, Saint. Paul, MN (US); Jonathan T. KAHL, Saint Paul, MN (US); Anthony J. SABELLI, White Plains, NY (US); Shannon D. SCOTT, Saint Paul, MN (US); Robert W. SHANNON, Saint Paul, MN (US)

(21) Appl. No.: 15/557,114

(22) PCT Filed: Mar. 3, 2016
(86) PCT No.: PCT/US2016/020592

§ 371 Date: Sep. 10, 2017

Related U.S. Application Data
(62) Division of application No. 62/130,886, filed on Mar. 10, 2015.

(51) Int. Cl. G06T 15/10; G06K 9/00; G06K 9/20; G06T 17/20

(52) U.S. Cl. CPC G06T 15/10; G06T 17/20; G06K 9/0008; G06K 9/00073; G06K 9/00013; G06K 9/2054; G06K 9/00093; G06K 9/001

(57) ABSTRACT

A non-parametric computer implemented system and method for creating a two dimensional interpretation of a three dimensional biometric representation. The method comprises: obtaining with a camera a three dimensional (3D) representation of a biological feature; determining a region of interest in the 3D representation; selecting an invariant property for the 3D region of interest; identifying a plurality of minutiae in the 3D representation; mapping a nodal mesh to the plurality of minutiae; projecting the nodal mesh of the 3D representation onto a 2D plane; and mapping the plurality of minutiae onto the 2D representation of the nodal mesh. The 2D representation of the plurality of minutiae has a property corresponding to the invariant property in the 3D representation; and the value of the corresponding property in the 2D projection matches the invariant property in the 3D representation.

### TECHNICAL FIELD

The present invention relates to the field of virtually capturing biometric data, specifically fingerprints. More specifically, the present invention describes a system and method of virtually capturing a three-dimensional (3D) representation of fingerprints and converting the representation to a two-dimensional (2D) image or representation.

### BACKGROUND

Fingerprints and other biometric data are used by many government, commercial, residential, or industrial entities for a variety of purposes. These purposes include, for example, identifying individuals in forensic investigations using biometric data left at a scene of a crime, biometric access control, and authentication.

Successful use of biometric data relies on an existing database of biometric data with sufficient sample size, clarity and granularity such that newly collected biometric data can be matched to the existing sample in the database. Further, biometric data must be captured in a format compatible with the format of the biometric database so that a comparison between a newly captured sample and an existing sample in the database can be made.

Current fingerprint databases store fingerprints captured in one of several traditional methods. Traditional fingerprint capture methods include capture of a fingerprint based on contact of the finger with paper or a platen surface. A paper based method includes pressing an individual's finger against an ink source and then pressing and rolling the finger onto a piece of paper. A platen method includes pressing or rolling a finger against a hard surface (e.g., glass, silicon, or polymer) and capturing an image of the print with a sensor. Both paper and platen fingerprint capture methods have higher than preferable occurrence of partial or degraded images due to factors such as improper finger placement, skin deformation, slippage and smearing or sensor noise from wear and tear on surface coatings, or too moist or too dry skin.

To address the challenges with traditional fingerprint capture methods and concurrently create a fingerprint capture system that generates output compatible with existing fingerprint databases, several touchless finger imaging methods exist. However, these methods tend to introduce deformations into the fingerprint image when extracting a 2D image compatible with existing databases from a 3D finger image.

### SUMMARY

The present disclosure provides a new system and method for capturing a 3D representation of a biological feature and creating a 2D interpretation of the 3D representation. The method and system described is non-parametric, meaning that they do not involve any assumption as to the form or parameters of a model onto which the 3D representation is projected. Specifically, the system and method do not project the 3D representation onto standard geometric shapes (e.g., cylinder, cube, cone, sphere, etc.).

The present disclosure provides several advantages over prior methods and systems for collecting fingerprints. For example, the present disclosure substantially reduces or eliminates the occurrence of skin deformation, slippage and smearing. The present disclosure can achieve a larger captured finger area, allowing matching with a wider variety of finger samples. The present disclosure can retain proportional relation between various features or ridges when creating a two dimensional interpretation of a three dimensional biometric representation. The present disclosure also supports touchless imaging technology, providing faster acquisition of fingerprints by reducing the length of time and hardware requirements necessitated for ink, paper, or platen sensor based capture.

In one instance, the present disclosure includes a non-parametric computer implemented method for creating a two dimensional interpretation of a three dimensional biometric representation. The method includes obtaining a three dimensional (3D) representation of a biological feature; determining a region of interest in the 3D representation; identifying a plurality of minutiae in the 3D region of interest; mapping a nodal mesh to the plurality of minutiae; projecting the nodal mesh of the 3D region of interest onto a 2D plane to create a 2D representation of the nodal mesh; and mapping the plurality of minutiae onto the 2D representation of the nodal mesh. A surface area of the 3D region of interest matches a surface area of the 2D representation of the plurality of minutiae.

In another instance, the present disclosure includes a system for creating a two dimensional interpretation of a three dimensional biometric representation. The system comprises: at least one camera to obtain a three dimensional (3D) representation of a biological feature; and a processor to receive the 3D representation from the camera, wherein the processor determines a region of interest in the 3D representation. The processor identifies a plurality of minutiae in the 3D region of interest, maps a nodal mesh to the plurality of minutiae, projects the nodal mesh of the 3D region of interest onto a 2D plane, and maps the plurality of minutiae onto the 2D representation of the nodal mesh. The surface area of the 3D region of interest matches the surface area of the 2D representation.

In another instance, the present disclosure includes a non-parametric computer implemented method for creating a two dimensional interpretation of a three dimensional biometric representation. The method comprises: obtaining with a camera a three dimensional (3D) representation of a biological feature; determining a region of interest in the 3D representation; selecting an invariant property for the 3D region of interest; identifying a plurality of minutiae in the 3D representation; mapping a nodal mesh to the plurality of minutiae; projecting the nodal mesh of the 3D representation onto a 2D plane; and mapping the plurality of minutiae onto the 2D representation of the nodal mesh. The 2D representation of the plurality of minutiae has a property corresponding to the invariant property in the 3D representation; and the value of the corresponding property in the 2D projection matches the invariant property in the 3D representation.

In another instance, the present disclosure includes system for creating a two dimensional interpretation of a three dimensional biometric representation. The system comprises: at least one camera to obtain a three dimensional (3D) representation of a biological feature; and a processor to receive the 3D representation from the camera, wherein the processor determines a region of interest in the 3D representation. The processor determines an invariant property for the 3D region of interest, identifies a plurality of minutiae in the 3D representation, maps a nodal mesh to the plurality of minutiae, projects the nodal mesh of the 3D representation onto a 2D plane, and maps the plurality of minutiae onto the 2D nodal mesh. The 2D representation of the plurality of minutiae has a property corresponding to the invariant property in the 3D representation, and the value of the corresponding property in the 2D projection matches the invariant property in the 3D representation.

In another instance, the present disclosure includes a non-parametric computer implemented method for creating a two dimensional interpretation of a three dimensional biometric representation. The method comprises: obtaining a three dimensional (3D) representation of a biological feature; determining a region of interest in the 3D representation; identifying a plurality of minutiae in the 3D region of interest; mapping a nodal mesh to the plurality of minutiae, the nodal mesh including a plurality of points connected by lines; projecting the nodal mesh of the 3D region of interest onto a 2D plane to create a 2D representation of the nodal mesh. The method further includes comparing angle measurements between some of the lines in the 3D nodal mesh to angle measurements between the corresponding lines in the 2D nodal mesh, and adjusting the angles between the corresponding lines in the 2D when they exceed a deviation threshold when compared to the angle measurements in the 3D representation.

In some embodiments, the 3D representation of a biological feature is obtained from one or more 3D optical scanners.

In some embodiments, the features are at least one of: ridges, valleys and minutiae.

In some embodiments, the identifying step uses linear filtering of either geometric or texture features. In some of these embodiments, the identifying step further comprises comparing a Laplacian filtered 3D representation to the original 3D representation.

In some embodiments, the biological feature is a fingerprint.

In some embodiments, the camera is a 3D optical scanner.

### BRIEF DESCRIPTION OF DRAWINGS

The following figures provide illustrations of the present invention. They are intended to further describe and clarify the invention, but not to limit scope of the invention.

FIG. 1 shows five exemplary fingerprints captured using a traditional contact process.

FIG. 2 shows a flowchart for a method of creating a 2D representation of a 3D fingerprint mesh.

FIG. 3 shows an exemplary 3D representation of a fingerprint, including the fingerprint minutiae.

FIG. 4 shows a nodal mesh overlaid on an exemplary region of interest within a 3D representation of a fingerprint.

FIG. 5 shows the nodal mesh from FIG. 4.

FIG. 6 shows a projection of the 3D nodal mesh onto a 2D plane.

FIG. 7 shows fingerprint minutiae mapped onto the 2D nodal mesh.

FIG. 8 shows a 2D representation of the fingerprint minutiae.

Like numbers are generally used to refer to like components. The drawings are not to scale and are for illustrative purposes only.

### DETAILED DESCRIPTION

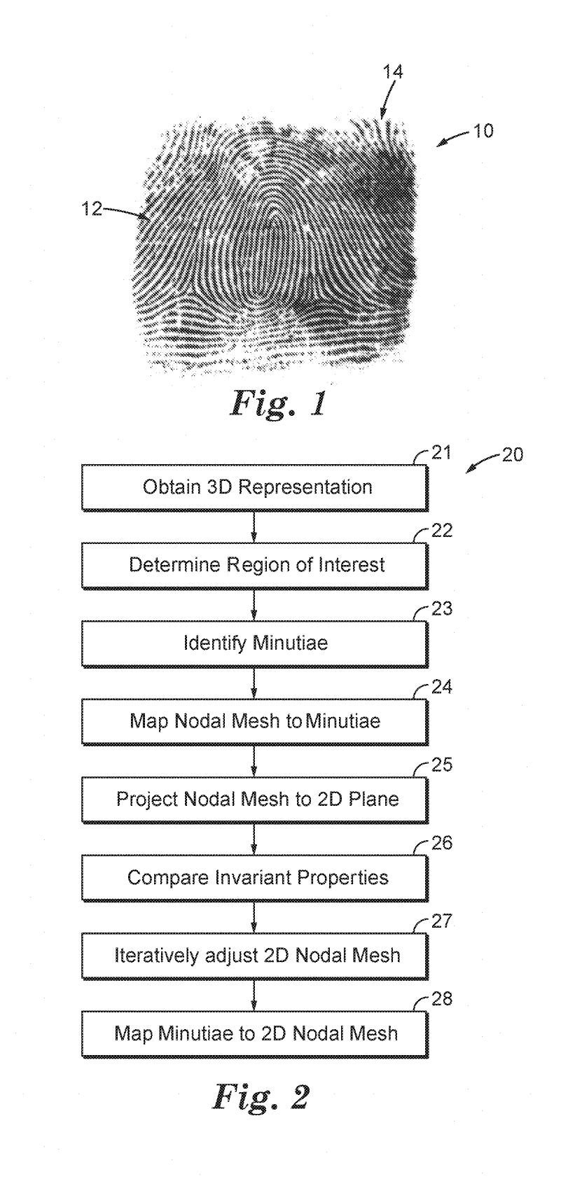

FIG. 1 shows five exemplary fingerprints 10 captured using a traditional contact process. While traditional fingerprint capture methods include a number of methods, these fingerprints 10 were captured by pressing or rolling a finger against a hard surface (e.g., glass, silicon, or polymer) and capturing an image of the print with a sensor. When fingerprints are captured, a primary concern is capturing fingerprint minutiae 12, which are the identifiable features of a fingerprint. Minutiae 12 can include, for example:
Ridge ending: the abrupt end of a ridge;
Ridge bifurcation: a single ridge that divides into two ridges;
Short or Independent ridge: a ridge that commences, travels a short distance, and then ends;
Island: a single small ridge inside a short ridge or ridge ending that is not connected to all other ridges;
Ridge enclosure: a single ridge that bifurcates and reunites shortly afterward to continue as a single ridge;
Spur: a bifurcation with a short ridge branching off a longer ridge;
Crossover or Bridge: a short ridge that runs between two parallel ridges;
Delta: a Y-shaped ridge meeting; and
Core: a U-turn in the ridge pattern.
   Minutiae 12 can be used to match a collected sample to a reference fingerprint stored in a database to potentially identify the individual providing the collected sample assuming that the reference fingerprint is stored in the database.

The fingerprints 10 in FIG. 1 illustrate the form of fingerprints stored in many existing fingerprint databases. To match newly collected fingerprint samples to these existing prints, it is important that the collected samples be the same or in a similar format so that a match can be made, either using matching algorithms that are deployed in Automatic Fingerprint Identification Systems (AFIS) or human matching techniques such as those followed in a multi-stage Analysis, Comparison, Evaluation, and Verification (ACE-V) process.

Each fingerprint shown in FIG. 1 covers a particular surface area as defined by its edges 14. Occasionally, when a fingerprint sample is collected, the area captured extends beyond the area of a finger that is useful for purposes of fingerprint matching. In other instances, portions of the capture print area may be useful for purposes of fingerprint matching. In other instances, the entire captured print is useful for purposes of fingerprint matching.

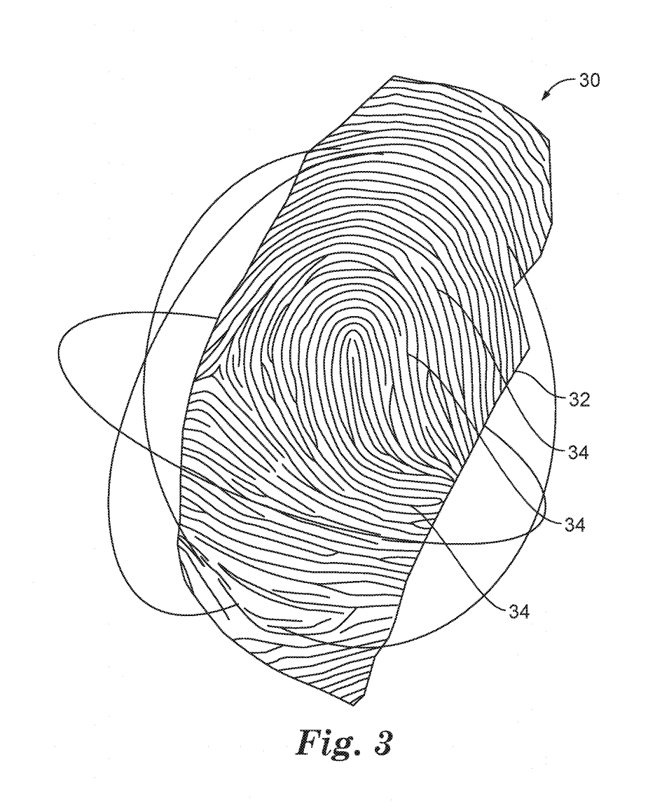

FIG. 2 shows a flowchart 20 for a method of creating a 2D representation of a 3D fingerprint mesh. While flowchart 20 provides information on the process for creating a 2D representation of a 3D fingerprint image, many variations of flowchart 20 may be implemented consistent with the present disclosure. For example, additional steps may be included between the numbered steps, steps may be performed at the same time, and steps may be performed in a different order than shown in FIG. 2.

Step 21 obtains a three dimensional (3D) representation of a biological feature. In some instances, the biological feature may be a fingerprint. Other biological features may include latent fingerprints, palm prints, iris scans, tattoos, facial images, and/or ear images. The 3D representation can be obtained in a variety of ways. For example, it may be obtained using one or more cameras or optical scanners and processing the images captured by the camera to create a 3D representation.

Step 22 determines a region of interest in the 3D representation. The region of interest may include the entire region captured represented in the 3D representation or may be a subset of the region captured and represented in the 3D representation. There are a variety of ways to determine what portion of the 3D representation should be included in the region of interest. Factors for determining the region of interest include using only regions with high data integrity and using regions most commonly used in applications, such as biometric matching applications. For example, a region of interest of a 3D representation of a finger may include the area of skin spanning from one side of a fingernail to the other side of the fingernail, and may also include the skin on the fingertip.

Step 23 identifies a plurality of minutia in the 3D region of interest. In the instance where the biological feature is a fingertip, the minutiae are typically ridges, valleys, and the specific minutiae described with respect to FIG. 1. The identified minutiae may include all identifiable minutiae in the region of interest, or may include some of the identifiable minutiae in the region of interest. Step 23 may use additive smoothing, differential smoothing or a combination thereof of either geometric or texture features to identify a plurality of minutiae. In another instance, step 23 may include comparing a Laplacian smoothed 3D representation to the original 3D representation to identify a plurality of minutiae.

In instances where the biological feature is an iris scan, face image, tattoo, fingerprint, palm print, latent print, ear or other biological feature, the minutiae will vary from those used in the instance of fingerprint. For example, when the biological feature is an iris scan, the minutiae may include rings, furrows, freckles, arching ligaments, ridges, crypts, corona, and/or a zigzag collarette. When the biological feature is a face image, the minutiae may include peaks between nodal points; valleys between nodal points; position of eyes, nose, cheekbones, or jaw; size of eyes, nose, cheekbones, or jaw; texture, expression, and/or shape of eyes, nose, cheekbones, and/or jaw. When the biological feature is a tattoo, the minutiae may include patterns, shapes, colors, sizes, shading, and/or texture. When the biological feature is a fingerprint, palm print, or latent print, the minutiae may include friction ridges, loops, whorls, arches, edges, bifurcations, terminations, ending ridges, pores, dots, spurs, bridges, dots, islands, ponds, lakes, crossovers, scars, warts, creases, incipient edges, open fields, and/or deformations. When the biological feature is an ear image, the minutiae may include edges, ridges, valleys, curves, contours, boundaries between anatomical parts, helices, lobes, tragus, fossa, and/or a concha.

Step 24 maps a nodal mesh to the plurality of minutiae. A nodal mesh includes a set of points where at least some of the points are mapped to at least some of the plurality of minutiae or correspond to points that appear on the 2D or 3D surface. A nodal mesh may be 2D or 3D. Each point of the nodal mesh is connected to at least two or three or more adjacent points by a line reaching directly from the originating point to the adjacent point. The spaces enclosed by lines approximate the surface of the 3D representation of the biological feature.

Step 25 includes projecting the nodal mesh of the 3D region of interest onto a 2D plane to create a 2D representation of the nodal mesh. A variety of computational approaches can be taken to minimize the distortion created by projecting the 3D representation onto a 2D plane. Examples of such approaches include using principal component analysis (PCA) to determine the direction of variance is minimal and linearly projecting the nodes to a plane along the determined direction. The initial projection begins invariant property matching iteration as further described in Step 26.

Step 26 includes comparing the invariant property for the 2D representation to the corresponding invariant property for the 3D representation to determine whether the invariant property of the 2D representation matches the invariant property of the 3D representation. Examples of invariant properties includes: surface area, spatial ridge frequency, average ridge to ridge distance, or angle of surface facets. Invariant properties are typically represented in scalar numbers. Two scalars match when the absolute value of the difference is equal to or smaller than a threshold. A threshold can be related to the iterative process and the underlying 3D geometry. For example, in one exemplary embodiment, the threshold may be a scalar, a percentage of the scalar value that you're matching, or controlled by a more complex computer algorithm.

If the invariant properties of the 3D and 2D representations do not match, the 2D projection is iteratively adjusted in Step 27 until the invariant properties do match.

In step 28, the plurality of minutiae are projected or mapped onto the 2D projection of the nodal mesh to create a 2D representation of the 3D biological feature. The minutiae are projected by mapping a minutiae to the node it was originally mapped to. Minutiae or other textures occurring between nodes are proportionally projected into the space between nodes to minimize distortion in the 2D representation of the 3D biological feature.

FIG. 3 shows an exemplary 3D representation 30 of a fingerprint, including the fingerprint minutiae. The 3D representation 30 can be captured in a variety of ways, as discussed in detail herein. The 3D representation 30 includes edges 32. In this instance, the edges define the boundary of a region of interest of the 3D representation. In other instances, the region of interest may be a subset portion of the 3D representation. 3D representation 30 includes many minutiae 34.

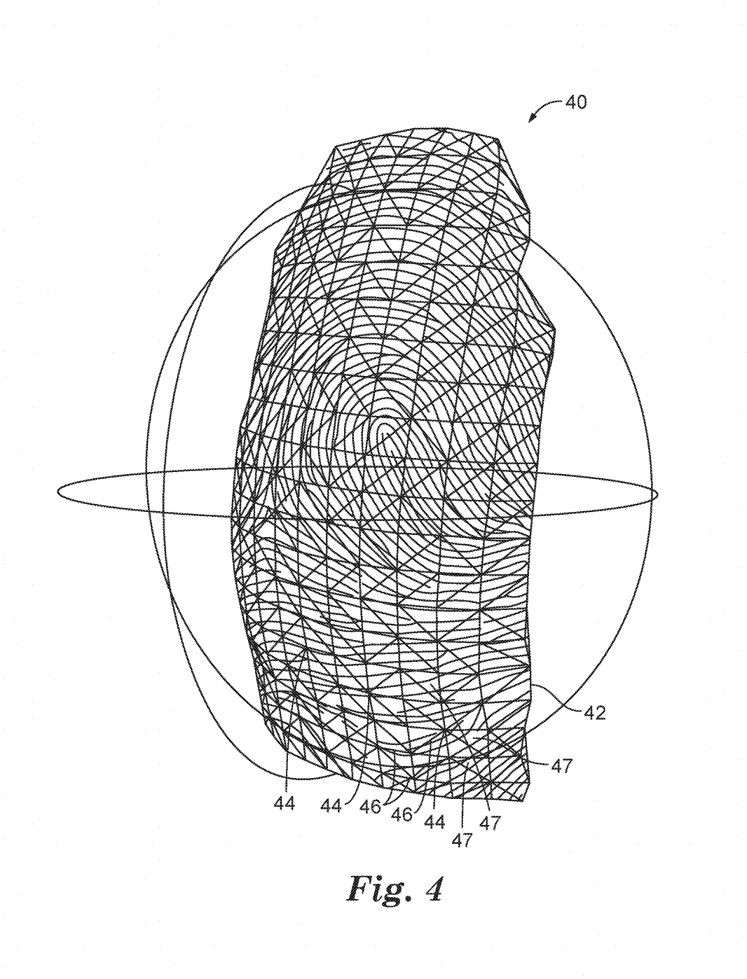

FIG. 4 shows a nodal mesh overlaid on an exemplary region of interest 40 within a 3D representation of a fingerprint. Nodal mesh 40 is overlaid on region of interest 40 such that nodes 44 are mapped to some of the plurality of minutiae included in the region of interest 40. Lines 46 connect nodes 44 to create surfaces 47 that approximate the surface of the region of interest 40 of the 3D representation.

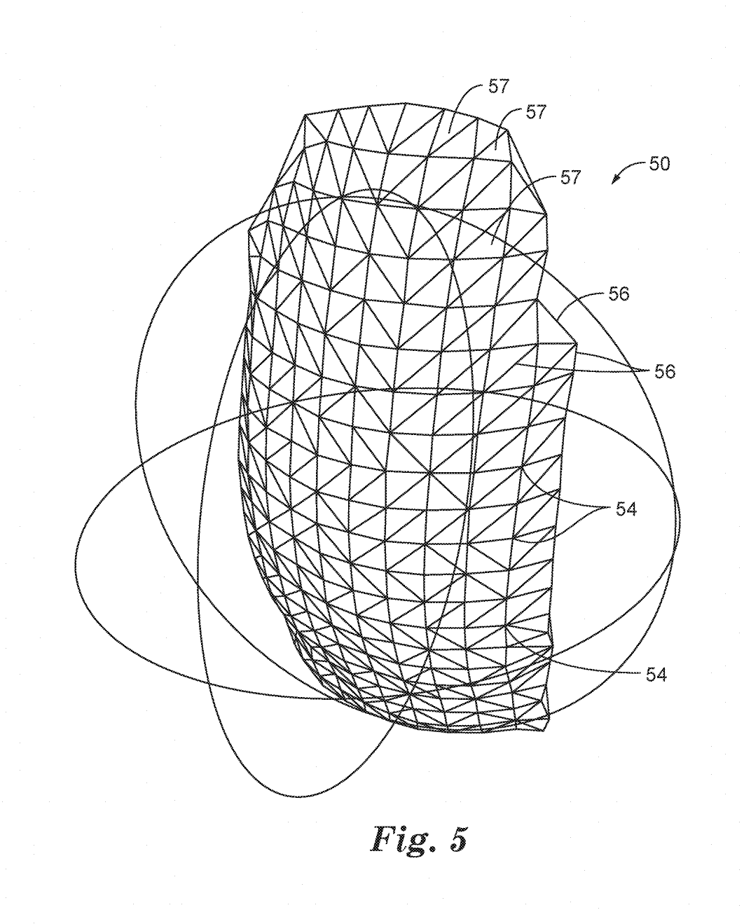

FIG. 5 shows the nodal mesh 50 from FIG. 4 without the texture originally captured and shown in region of interest of the 3D representation of the fingerprint. Lines 56 connect nodes 54 to create surfaces 57 that approximate the surface of the region of interest of the 3D representation.

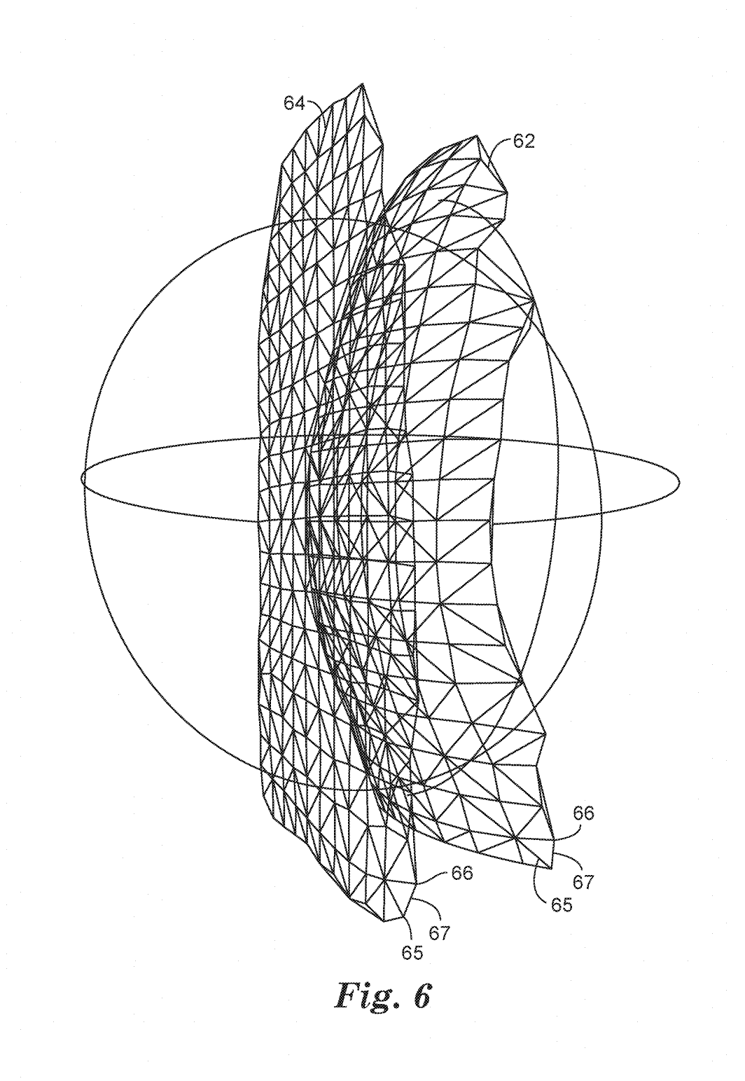

FIG. 6 shows a projection of the 3D nodal mesh 62 onto a 2D plane to create a 2D nodal mesh 64. The projection is designed to minimize distortion that can occur during the projection process. Each of the 2D nodal mesh 64 and the 3D nodal mesh 62 has a corresponding invariant property, and the projection process can be repeated iteratively until the invariant property of the 2D nodal mesh 64 matches the corresponding invariant property of the 3D nodal mesh 62. When the 3D nodal 62 mesh is projected onto the 2D plane to create the 2D nodal mesh 64, relationships between the adjacent points are maintained such that two adjacent points are still connected by a line extending directly from the originating point to the adjacent point. For example, point 65 is connected to point 66 by line 67 in each of the 3D nodal mesh 62 and the 2D nodal mesh 64 even though the relative positions of point 65, point 66 and line 67 are slightly changed due to the projection from 3D to 2D.

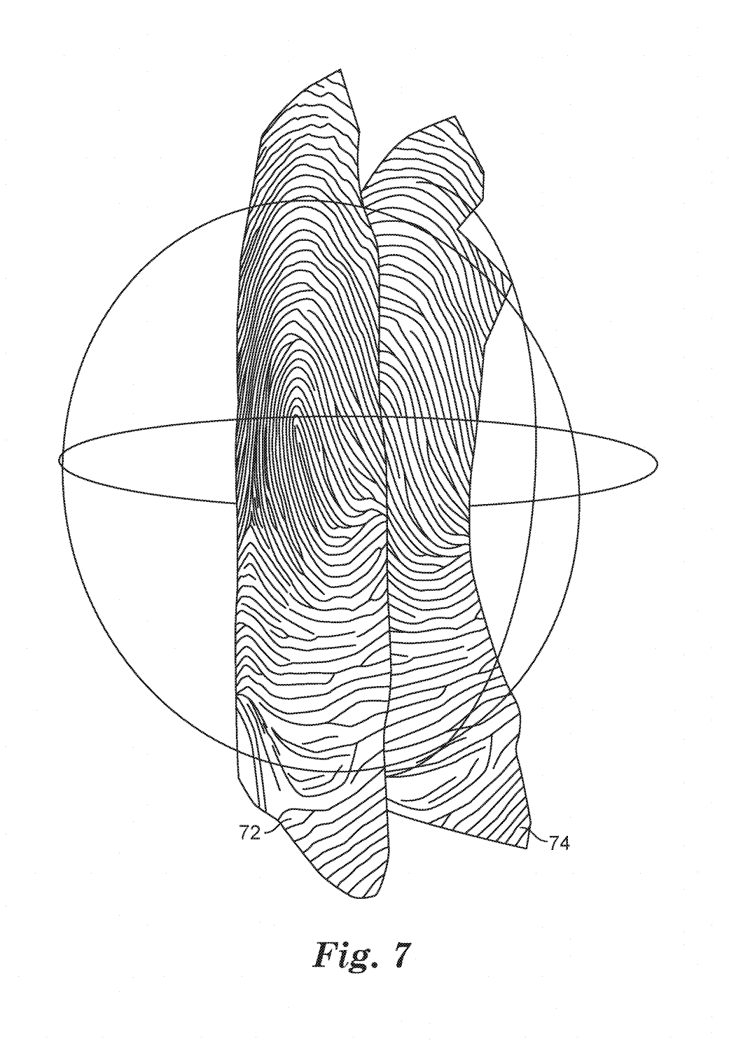

FIG. 7 shows fingerprint minutiae 72 projected onto a 2D plane by mapping the 3D representation of the minutiae 74 onto the 2D nodal mesh. The minutiae are projected by mapping a minutia to the node it was originally mapped to in the 3D representation of the fingerprint as shown, for example, in FIG. 4. Minutiae 74 or other textures occurring between nodes are proportionally projected into the space between nodes to minimize distortion in the 2D representation of the 3D biological feature.

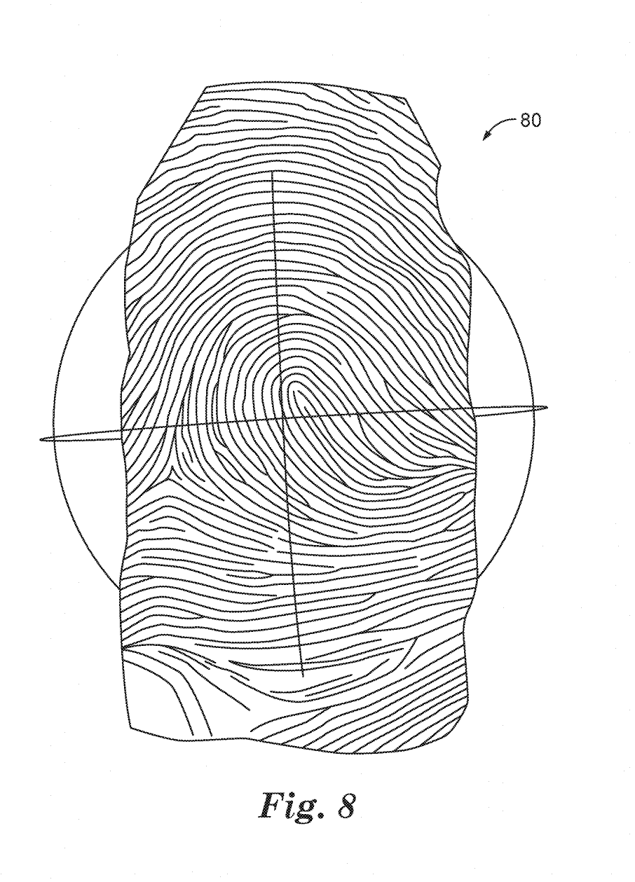

FIG. 8 shows a 2D representation 80 of the fingerprint minutiae. The 2D representation can be used to identify the individual whose fingerprint is captured consistent with the present disclosure by comparing the 2D representation 80 with a database of known fingerprints, including fingerprints captured using traditional methods or those captured using a method as described in the present disclosure.

### EXAMPLE

Preservation of Surface Area for 3D to 2D Fingerprint Representation.

To accurately represent three dimensionally captured fingerprints in two dimensions, equivalent consideration was necessary for hardware and software interaction and performance. Although the example is directed toward fingerprint acquisition and analysis, system requirements, operation, and analysis would be applicable for conversion of other biometric information including, but not limited to, palm prints and facial images. Simple, yet expansive, multiple application operation led to the establishment of component and system requirements enabling robust, repeatable data capture and conversion.

Applicants created a system for capturing a three dimensional image of a fingerprint. Several factors were considered in selecting an image sensor to capture three dimensional (3D) representations including pixel count, image size, format, frame rate, and spectral response. A 5 Megapixel (MP) Aptina Imaging MT9P031 monochrome sensor manufactured by On Semiconductor of Phoenix, Ariz. was selected as the image sensor. Operation of the sensor also provided a balanced tradeoff between frame rate (i.e., ≧8 frames per second) and image size (i.e., ≦2592×1944 pixels). The MT9P031 performance aligned with requirements of the Federal Bureau of Investigation (FBI)'s image quality specification (SPEC) for Personal Identity Verification (PIV) single fingerprint capture devices. The selected sensor performance peaks within the green and blue spectrum to align well with the reflective response on human skin.

The SPEC also requires spatial image resolution to meet and exceed 500 pixels per inch (ppi) in sensor row and column directions. The DMK 23UP031 USB 3.0 monochrome industrial camera from The Imaging Source of Charlotte, N.C. is one such camera capable of meeting that requirement. Two such cameras were required to acquire and convert 3D multiple two target representations of fingerprints into two dimensions (2D).

The two cameras were calibrated, which involved determining correspondence between two target images (referred to as left and right) within the target space of the finger or object of interest. The objective of calibration is to fit both intrinsic and extrinsic parameters of the optical elements. Intrinsic parameters are distinct for each camera and consisted of horizontal and vertical focal lengths, and image center. In addition, various distortion models were fitted to capture and ultimately correct for common optical artifacts like pincushion or barrel distortion. Extrinsic parameters included rotation matrices and a translation vectors which were required to transform one camera center to the other. Parameters were determined by minimizing the joint re-projection error of the two cameras. Open source computer vision libraries of programming functions (i.e., OpenCV) provided operations to perform minimization along with computational techniques which extrapolated the parameters near their final values. For example, initial focal length estimates are based on lens specifications and image center estimates are based on frame size. High quality annotated correspondences between each image and target space of the finger or object of interest are also estimated. These annotations, coupled with initial parameter estimates are fed to the numerical optimization routines to determine final, and optimal, camera parameters. After the camera parameters are found, an optimal image rectification homography is identified for each camera. Specifically, a homography is identified for each frame that aligns epipolar lines and minimizes the disparity (in a least squares sense) in the annotated calibration correspondences. A technique followed to determine rectification homographies is described in Hartley, R. Multiple View Geometry in Computer Vision. Cambridge University Press, 2004. p. 304-307. A multitude of techniques are known in the industry and many others could have been implemented to achieve calibration, and would be apparent to one of skill in the art upon reading this disclosure.

Left and right camera images required annotation and common image processing techniques, such as thresholding or mask shift, were used to identify dots in single pixel resolution within each of the images. Centers of the dots were estimated through the construction of a grid by fitting a line to each of a horizontal and vertical neighborhood of dots and determining the point of intersection. Models were computed using orthogonal distance regression (ODR) to find the maximum likelihood of the dot center as well as measurement of error. To improve accuracy and reduce error, the neighborhood size was selected to fit intersecting lines by using ±2 calibration dots for each of the horizontal and vertical lines. Using planar Iterated Closest Point (ICP), the annotated grid was registered to a 101×101 grid.

In order to align images obtained from the left and right cameras, parameters of each aperture corresponding to optical distortion, focal length, and principal point were calibrated. Calibration was initially performed separately on each aperture by introducing an approximate intrinsic matrix where the focal length was approximated by the ratio of the nominal focal length of the lens (in millimeters) over the pixel size (in millimeters). Open CV was used to calibrate each aperture to obtain an intrinsic matrix, distortion parameter vector, and re-projection error. Levenberg-Marquardt methods available in OpenCV were implemented to perform further optimization on the parameters of interest. The calibration process was iterated until optimal intrinsic, extrinsic, and distortion parameters were obtained that resulted in the construction of a fundamental matrix (i.e., F matrix), which defined the relationship between the left and right images whereby mapping epipolar lines from one aperture to the other. Iteration continued until error in the objective function or the change in the objective function was below a threshold (i.e., 1e-10) or some preset number of iterations is met (i.e., 30).

Pairwise assessment was performed on the F matrix to determine homographies to match epipolar projections. Techniques described in Hartley, R. Multiple View Geometry in Computer Vision. Cambridge University Press, 2004. P. 304-307 computed a homography on the left image by mapping the epipole to infinity. Specific rows in the right homography were selected by:

Hᵣ=[i]ₓHₗ^{-T}F^{T} (1)

where Hᵣ and Hᵢ correspond to the right and left homographies, F is the fundamental matrix from the parameter optimization, and [i]ₓ is the cross matrix for the i direction. A least square difference (LSD) optimized through techniques described in Hartley, R. Multiple View Geometry in Computer Vision. Cambridge University Press, 2004. p. 304-307 was performed between the left and right image coordinates once Hᵣ and Hₗ were applied to the coordinates of the calibrated dots and the homographies were stored for use in 3D reconstruction.

Five steps were performed to reconstruct a 3D representation of the finger or object of interest and included: 1) rectification, 2) correspondence, 3) 3D triangulation, 4) filtering/meshing, and 5) texture mapping.

Calibrated homographies were rectified to remove distortions or other variations which potentially arose during assembly and calibration. OpenCV functions and Lanczos resampling were used individually or in combination to remove distortion while ensuring that high frequency information such as friction ridges or other parameters were not impacted, modified, or eliminated.

To correct for pixel shift that may have arisen between features on the left and right images, the images may be further rectified using a process called correspondence. The process or method effectively tunes or refines one or multiple parameters to prepare for re-projection or triangulation of the generated 3D points within the images. Correspondence was accomplished using semi-global block matching techniques that are available in open source computer vision. Pixel shifts occur within each row and were sought such that:

Iᵣ^{r}(x,y)=Iₗ^{r}(x+d(x,y),y) (2)

where Iᵣ^{r} and Iₗ^{r} are the right and left rectified images and d(x,y) is a disparity field. A non-linear block by block correlating disparity field was selected based upon its speed, accuracy, and density and was available through OpenCV function. Once the disparity field was selected, coordinates of features identified in left rectified image (x, y) correspond to features identified in the right rectified image (x+d(x, y), y).

Triangulation, or re-projection, is the process of identifying which 3D points correspond to features contained in each of the left and right frame. Application of an inverse function to the left and right homographies produced coordinates in the unrectified and undistorted frames. An optimal triangulation method as described in Hartley, R. Multiple View Geometry in Computer Vision. Cambridge University Press, 2004. p. 318 was then applied to obtain the original coordinates of features contained within the original undistorted image. The method optimally corrected correspondences that did not fall on the epipolar lines of each other. A correlation vector was calculated in each of the left and right frames to move the coordinates so that they fell on epipolar lines ensuring that light traveling through the camera apertures and the feature coordinates intersect in the target space of the finger or object of interest. Triangulation resulted in the creation of a 3D point cloud.

An optional time stitching step may be performed to minimize noise and align the signals received and processed from the left and right images. The objective of time stitching is to find rotations and translations for point clouds generated by left and right images at different points in time. For example, a point cloud may be created from each pair of n synchronized frames that were analyzed. Movement of the cameras relative to the finger or object of interest may require registering the output points to the previous point cloud. Time stitching may involve the process of mapping image coordinates to finger or object of interest coordinates for the left frame at two or more successive points in time. Corresponding points in the left frame may then be identified across the two or more successive points in time. Image-to-object and/or image-to-image correspondences may then be used to find correspondence between points on the object. Rotation and translation are found by connecting the two point clouds using Procrustes analysis or other similar assessment techniques.

Upon creation of a 3D point cloud, meshing and filtering techniques were used to extract a 2D surface. Common techniques include variants of Marching Cubes, Point Cloud Library (PCL) and Hoppe representations. Assuming that the surface of an image may be projected to an image without overlapping itself, Delaunay triangulation was used on the projection of the points along the optical axis. Due to the implementation of dense image correspondence techniques, one million points per frame were present. These points contained noise and are computationally extensive. The points were subsequently down-sampled, from 1e6 to 1e2 points for example, before projecting and performing Delaunay triangulation. Down-sampling was performed by voxelizing the space around the points and replacing the points in each voxel with a center point.

Upon conclusion of the filtering/meshing step, a 2D surface was produced comprised of interconnected points. The pattern was represented as a collection of edge-connected triangles. Nodes of the triangles were projected to the original left image that was used to create the surface. The original image was then used to provide texture on each of the triangles.

In order to represent a finger captured in three dimensions in two dimensions, a plane was defined by using Principal Component Analysis of the identified point clouds obtained by the analyzing the filtered/mesh surface. Using simple linear projection through a gradient descent method, the boundary vertices on the mesh surfaces were projected to the plane. Interior nodes were identified by using Laplacian interpolation and the computation and modification of a Laplace-Beltrami matrix (L). The matrix and its application are described in Bosch, M. Polygon Mesh Processing. A K Peters/CRC Press. 2010 p. 44. The matrix was modified with the following constraints:

L_{i,j}=0 if xᵢ is a boundary vertix and i≠j

L_{i,j}=1 if xᵢ is a boundary vertix and i=j

To interpolate the interior nodes two systems were solved:

L\hat{x}=Bₓ

Lŷ=B_{y}

where Bₓ is the vector where the i^{th} coordinate is equal to zero if xᵢ is an interior node and equal to the x coordinate if xᵢ is a boundary node. B_{y}, is defined similarly, and the i^{th} coordinate is equal to zero if xᵢ is an interior node and equal to the y coordinate of xᵢ if xᵢ is a boundary node. The solution vectors \hat{x} and ŷ are the coordinates of the interpolated vertices. An objective function was defined as the squared difference of the surface area of the 3D surface and the 2D projected surface. Transformation from 3D to 2D continued by iteratively updating 1) the boundary vertices by minimizing the objective function and 2) the interior vertices using Laplacian interpolation. Minimization occurred when the surface areas are substantially the same. Thus, the surface area of the 3D surface is preserved during transformation to a 2D surface.

The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

What is claimed is:

1. A non-parametric computer implemented method for creating a two dimensional interpretation of a three dimensional biometric representation, the method comprising:
obtaining a three dimensional (3D) representation of a biological feature;
determining a region of interest in the 3D representation;
identifying a plurality of minutiae in the 3D region of interest;
mapping a nodal mesh to the plurality of minutiae
projecting the nodal mesh of the 3D region of interest onto a 2D plane to create a 2D representation of the nodal mesh; and
mapping the plurality of minutiae onto the 2D representation of the nodal mesh;
wherein a surface area of the 3D region of interest matches a surface area of the 2D representation of the plurality of minutiae.

2. The method of claim 1 wherein the 3D representation of a biological feature is obtained from one or more 3D optical scanners.

3. The method of claim 1, wherein the features are at least one of: ridges, valleys and minutiae.

4. The method of claim 1, wherein the identifying step uses linear filtering of either geometric or texture features.

5. The method of claim 4, wherein the identifying step further comprises comparing a Laplacian filtered 3D representation to the original 3D representation.

6. The method of claim 1, wherein the biological feature is a fingerprint.

7. A system for creating a two dimensional interpretation of a three dimensional biometric representation, the system comprising:
at least one camera to obtain a three dimensional (3D) representation of a biological feature;
a processor to receive the 3D representation from the camera, wherein the processor determines a region of interest in the 3D representation;
wherein the processor identifies a plurality of minutiae in the 3D region of interest, maps a nodal mesh to the plurality of minutiae, projects the nodal mesh of the 3D region of interest onto a 2D plane, and maps the plurality of minutiae onto the 2D representation of the nodal mesh;
wherein the surface area of the 3D region of interest matches the surface area of the 2D representation.

8. The system of claim 7, wherein the camera is a 3D optical scanner.

9. The system of claim 7, wherein the features are at least one of: ridges, valleys and minutiae.

10. The system of claim 7, wherein the biological feature is a fingerprint.

11. A non-parametric computer implemented method for creating a two dimensional interpretation of a three dimensional biometric representation, the method comprising:
obtaining with a camera a three dimensional (3D) representation of a biological feature;
determining a region of interest in the 3D representation;
selecting an invariant property for the 3D region of interest;
identifying a plurality of minutiae in the 3D representation;
mapping a nodal mesh to the plurality of minutiae;
projecting the nodal mesh of the 3D representation onto a 2D plane;
mapping the plurality of minutiae onto the 2D representation of the nodal mesh;
wherein the 2D representation of the plurality of minutiae has a property corresponding to the invariant property in the 3D representation;
wherein the value of the corresponding property in the 2D projection matches the invariant property in the 3D representation.

12. The method of claim 11 wherein the camera is a 3D optical scanner.

13. The method of claim 11, wherein the features are at least one of: ridges, valleys and minutiae.

14. The method of claim 11, wherein the identifying step uses linear filtering of either geometric or texture features.

15. The method of claim 14, wherein the identifying step further comprises comparing a Laplacian filtered 3D representation to the original 3D representation.

16. The method of claim 11, wherein the biological feature is a fingerprint.

17. The method of claim 11, wherein the invariant property is one of: surface area, spatial ridge frequency, or angle of surface facets.

18. A system for creating a two dimensional interpretation of a three dimensional biometric representation, the system comprising:
at least one camera to obtain a three dimensional (3D) representation of a biological feature;
a processor to receive the 3D representation from the camera, wherein the processor determines a region of interest in the 3D representation;
wherein the processor determines an invariant property for the 3D region of interest, identifies a plurality of minutiae in the 3D representation, maps a nodal mesh to the plurality of minutiae, projects the nodal of the 3D representation onto a 2D plane, and maps the plurality of minutiae onto the 2D nodal mesh;
wherein the 2D representation of the plurality of minutiae has a property corresponding to the invariant property in the 3D representation, and wherein the value of the corresponding property in the 2D projection matches the invariant property in the 3D representation.

19. The system of claim 18, wherein the camera is a 3D optical scanner.

20. The system of claim 18, wherein the features are at least one of: ridges, valleys and minutiae.

21. The system of claim 18, wherein the biological feature is a fingerprint.

22. The system of claim 18, wherein the invariant property is one of: surface area, spatial ridge frequency, or angle of surface facets.
